(19) United States
(12) Patent Application Publication
(10) Pub. No.: US 2010/0247311 A1
(43) Pub. Date: Sep. 30, 2010

(54) WIND ENERGY SYSTEM

(75) Inventors: Rainer Schlangen, Rheine (DE); Christian Kruse, Hamburg (DE)

Correspondence Address: Schwabe Williamson & Wyatt;PACWEST CENTER, SUITE 1900, 1211 SW FIFTH AVENUE, PORTLAND, OR, 97204, US

(73) Assignee: POWERWIND GMBH, Hamburg (DE)

(21) Appl. No.: 12/748,036

(22) Filed: Mar. 26, 2010

(30) Foreign Application Priority Data
Mar. 27, 2009 (DE) 102009015305.5-15

(51) Int. Cl. F03D 11/00

(52) U.S. Cl. 416/61

(57) ABSTRACT

The invention relates to a wind energy system comprising a tower, a nacelle attached to the tower, the interior of which can be entered, a rotor that is rotatable relative to the nacelle, with a hub, the interior of which adjoins the nacelle interior and is accessible from this via a connecting passage, and comprising a rotor stop mechanism, with which rotor rotation can be enabled in a released position and blocked in a locked position, wherein a warning device, which is controlled on the basis of the position of the rotor stop mechanism, and which can emit a warning signal against accessing the hub interior when the rotor stop mechanism is in the released position [sic—Translator].

The invention relates to a wind energy system comprising a tower, a nacelle attached to the tower, the interior of which can be entered, a rotor that is rotatable in relation to the nacelle, with a hub, the interior of which adjoins the interior of the nacelle and is accessible from the interior of the nacelle via a connecting passage, and comprising a rotor stop mechanism, with which the rotation of the rotors can be enabled in a released position and blocked in a locked position.

Wind energy systems of this type (large-scale) are known, for example, in the form of the system operated by the applicant under the name PowerWind 56. The size of the rotor allows the hub interior to be accessed, for example for maintenance operations, with accessibility/access within the context of the claim being generally understood as at least a part of a person's body being able to fit into the interior area of the rotatable hub through the connecting passage. With large-scale systems such as the PW56, the hub can even be entered.

For safety reasons, however, the hub can be entered from the nacelle only when the system is stopped and the rotor stop mechanism is engaged. Otherwise, a rotation (idling) of the rotors could present a risk of injury to the operator working in the interior of the hub.

When the system is in operation, for example during test runs, in which persons, such as maintenance personnel, are working in the nacelle, a safety net or some other safety device stretched between nacelle and hub and blocking the connecting passage is ordinarily used to prevent a person from reaching the rotating hub. If it is necessary to enter the hub, first the system is stopped, and then the safety net is opened to allow access through the connecting passage. Before the safety net is opened, however, the prescribed procedure provides for the above-mentioned blocking of rotor rotation by engaging the rotor stop mechanism. Only then can the hub be accessed safely.

The object of the invention is to further improve upon the wind energy system described in the opening paragraph especially in terms of its safety engineering features.

This object is attained in accordance with the invention with a further improvement upon the wind energy system described in the opening paragraph, which is characterized essentially by a warning device that is controlled based upon the position of the rotor stop mechanism, wherein when the rotor stop mechanism is in the released position said device is able to emit a signal warning against accessing the interior of the hub.

The invention is based upon the knowledge that the existing safety measures and safety regulations are not always entirely satisfactory. For example, there is a risk that maintenance personnel will disregard safety regulations and will enter the hub after opening the safety net, without engaging the rotor stop mechanism beforehand. It is also conceivable that an operator seeing an opened safety net could mistakenly assume that the rotor stop mechanism has been engaged, and might enter the hub without confirming this assumption. In such cases, if an unexpected rotation or idling of the rotor should occur, it would in all probability result in injury to persons working in the hub.

This danger is eliminated or at least diminished by the warning device provided according to the invention. For instance, a person intending to enter the interior of the hub is made aware by the emitted warning signal that the rotor stop mechanism has not been engaged, and is thus warned to engage the rotor stop mechanism before entering the hub. Even if, for example, there is still a person in the hub when another person releases the rotor stop mechanism, the person in the hub is warned of the existing danger and can leave the hub in time, or can continue with his/her work once the rotor stop mechanism has been engaged again. This will result in fewer injuries to maintenance personnel.

According to one particularly preferred embodiment of the invention, a safety device, especially a safety net, is also provided, which prevents access to the hub interior when secured and allows such access when not secured, wherein the warning device is controlled based upon the status of the safety device. Thus the status of additional, already provided safety devices can be expediently integrated into the control of the warning device, thereby further increasing the functional range of the safety device.

It can also be provided that when the safety device is secured, no warning signal is emitted by the warning device. This takes advantage of the fact that, for example, the above-described safety net, when extended, already offers adequate protection against entering the hub, so that in this case emission of a warning signal can be dispensed with.

According to a preferred embodiment, the warning device for emitting the signal is activated if the safety device is unsecured while the rotor stop mechanism is released. In other words, it provides for a monitoring of the above-described safety provisions, in which a person will receive a warning when he/she is about to disregard safety regulations by unsecuring the safety device before the rotor stop mechanism is engaged.

In terms of structural engineering, the control system for the warning device has an electrical circuit with a first switch coupled to the rotor stop mechanism, wherein the switch closes when said mechanism shifts from the released position to the locked position and opens when it shifts from the locked position to the released position. The switch thus has both a sensor function for detecting the position of the rotor stop mechanism and a switching function within the control circuit of the warning device.

In a particularly expedient embodiment, the electrical control circuit has a contactor, and the warning device is deactivated for emitting the warning signal when the contactor is acted upon by a control current, and is activated for emitting the warning signal when the control current drops below a predetermined limiting current. Thus the warning device responds automatically when the control current in the control circuit drops, leading to an error-proof warning signal emission.

Preferably, when the first switch is closed the control current is flowing, i.e., it lies above the predetermined limiting current. The system for controlling the warning device of the invention is thereby implemented particularly simply.

In an advantageous embodiment, the electrical control circuit has a second switch coupled to the safety device, wherein the switch opens when said device is moved from the secured position to the unsecured position and closes when the device is moved from the unsecured position to the secured position. Thus coupling to the safety device is similar to coupling to the rotor stop mechanism, which enables a structurally simple implementation of the system for controlling the warning device.

In this connection, it is expediently provided that the control current is flowing when the second switch is closed. Thus a parallel connection of the two switches creates an inverse and-or circuit, with which the contactor is acted upon by a control current necessary for deactivating the warning device until either the rotor stop mechanism is engaged or the safety device is secured. Only when these two conditions are no longer met does the control current drop off, thereby activating the warning device to emit the warning signal.

In an expedient embodiment, the safety device has a safety element which is under tensile stress when it is secured. This element can be a tension cable of a safety net, for example. The latter can be easily implemented in the interior of the nacelle and hub, which are occupied by additional system components, as a reliable safety element for preventing unintended access to the hub.

In a particularly preferred embodiment, the second switch responds to a change in the tension of the safety element and opens when the tensile stress drops below a predetermined level. This serves to ensure that as soon as unsecuring of the safety device begins, an alarm is emitted if the rotor stop mechanism is not engaged, and that the removal of any impediment to access presented by the safety device is not absolutely necessary to trigger the alarm.

One expedient implementation of the rotor stop mechanism has a mechanical locking bolt. This enables a reliable arrest of the rotor while allowing, in particular, the attachment of a sensor for the first switch to the rotor stop mechanism/the locking bolt, thereby enabling a mechanically simple and reliable detection of the position of the rotor stop mechanism.

Moreover, it can be provided in a preferred embodiment that the sensor of the first switch responds only when the rotor stop mechanism is fully engaged. This serves to prevent a situation in which a deactivation of the alarm signal due to an incomplete rotor stop convinces the operator that the system is safe despite the fact that a release of the stop mechanism and consequently an idling of the rotor could still occur.

Preferably, the second switch has a sensor integrated into the safety element. This enables a quick response time for throwing the second switch.

In terms of the form of the warning signal, the invention is subject to no special restrictions. In particular, it can be provided that the warning signal contains an optical and/or acoustic signal. Preferably, an acoustic signal is used.

Additional advantages and details of the invention are found in the description of the attached set of figures, in which

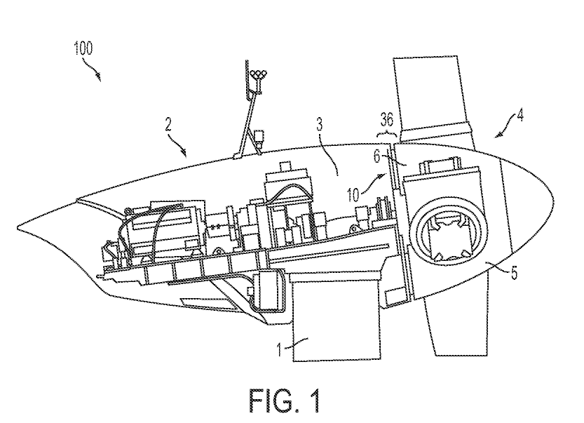

FIG. 1 shows a longitudinal section of the nacelle and the rotor hub of a wind energy system,

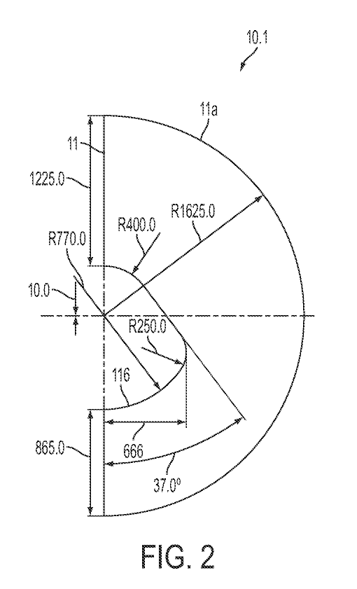

FIG. 2 shows a safety net,

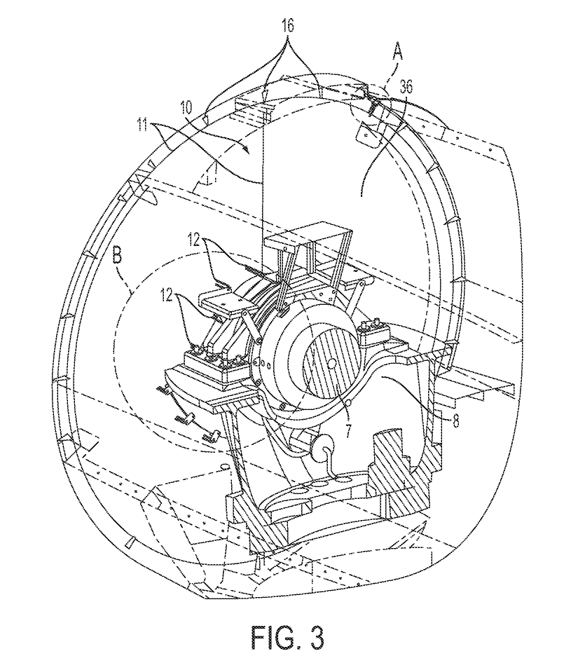

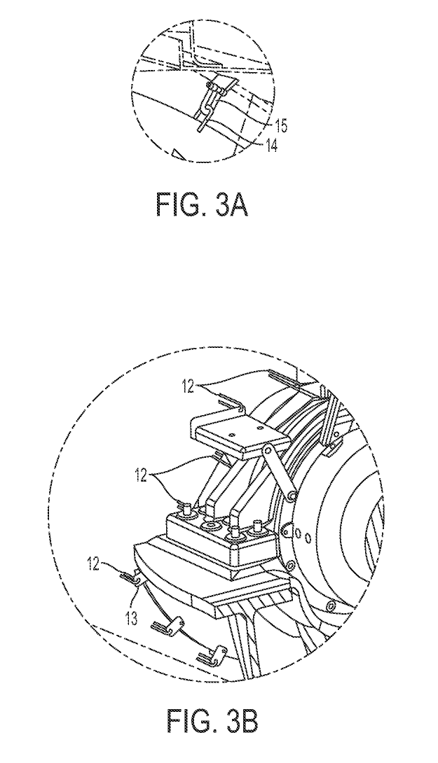

FIG. 3 shows a schematic cutaway view of a connecting passage from the interior of the nacelle to the interior of the hub,

FIG. 3A and 3B show enlarged sections of FIG. 3, and

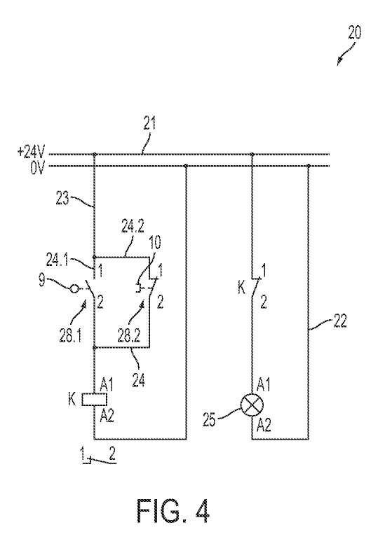

FIG. 4 shows a schematic view of the control system for a warning device.

FIG. 1 illustrates a longitudinal section of an area of a preferred exemplary embodiment of a wind energy system 100 that is essential to specifying the invention, comprising the upper area of a tower 1, a nacelle 2 positioned on said tower, and the hub 5 of the rotor 4, which is rotatable in relation to the nacelle 2. In the interior 3 of the nacelle 2, a mainframe is arranged in the customary fashion, which supports in a known manner the rotor axle suspension 8 and other machine parts which are required for the power generating operation of the wind energy system 100, but which are of subordinate significance to the invention and will therefore not be specified in any greater detail.

In the area of a connecting passage 36 between the nacelle interior 3 and the adjoining interior 6 of the rotor hub 5 a safety net 10 can be extended. The safety net 10 is comprised of two halves, with one half 10.1 being shown in FIG. 2 in a plan view in the direction of the rotor axle, with dimensions indicated merely by way of example. The net half 10.1, together with its net half 10.2, which is symmetrical in structure with the corresponding axis but is not shown here, encompasses the rotor axle 7, with the safety net 10 extending from the rotor axle suspension 8 up to the interior wall of the nacelle 2 in the area of the connecting passage 36, as viewed radially toward the rotor axle 7.

The safety net 10 is used to block the connecting passage 36, in order to prevent a person working in the nacelle interior 3 for maintenance purposes, for example, from entering the hub interior 6 of the rotating rotor hub 5 while the system 100 is in operation. To accomplish this, the safety net 10 is stretched tightly by securely fastening a tension cable 11, which extends around each respective net half 10.1 and 10.2, with clamps 13 along its radially inner rotational area 11b by a plurality of ties 12, with said clamps being attached to the rotor suspension 8. This is more clearly illustrated in FIG. 3, especially in the enlarged representation (FIG. 3b) of the area marked B.

At its radially outer rotational area 11a the tension cable 11 is latched under tension by means of snap hooks 14 into eyelets 15, which are arranged distributed around the inner wall of the nacelle 3 in the area of the connecting passage 36, as is also illustrated in FIG. 3 and in particular in the enlarged representation (FIG. 3a) of the area marked A. The tension cable 11/the safety net 10 are made of a suitable elastic material and can be removed by unlatching the snap hooks 14.

As long as the safety net 10, which is a knotless net with 5 mm thick fibers and a mesh size of 45 mm, for example, whereas the diameter of the continuous tension cable 11 is 12 mm in this embodiment, is securely tied radially toward the inside and is latched at multiple points around its perimeter radially toward the outside, a person working in the nacelle interior 3 is reliably denied access to the hub interior 6, and in particular, is also prevented from inadvertently falling into the hub 5, which, when the system 100 is undergoing test runs, for example, is rotating.

To allow intentional access to the hub interior 6, the snap hooks 14 at the points marked in FIG. 3 as 16 are released, thereby permitting access or entry into the hub interior 6.

According to valid safety regulations, however, the safety net 10 may be released (unhooked) only after both the system 100 has been shut off and a rotor stop mechanism 9, not shown in FIGS. 1-3, has been engaged, in order to reliably prevent the rotor 4 from idling thereby ensuring the safety of persons working in the hub interior 6.

To prevent a person from releasing the safety net 10 and thereby enabling access through the connecting passage 36 before the rotor stop mechanism 9 has been engaged, a warning device 20 is provided, which will now be specified in reference to FIG. 4. The warning device 20 has a signal emitter 25, which is located in a signal circuit 22 of a switching circuit 21. The switching circuit 21 also comprises a control circuit 23, which is connected in parallel to the signal circuit 22, with both being connected to a shared power source.

The control circuit 23 is coupled to the signal circuit 22 via a contactor K, which is controlled by the flow of current in the control circuit 23, as follows. When the control current in the control circuit 23 drops below a preset level, thereby releasing the contactor K, this closes the signal circuit 22, which activates the signal emitter 25 causing it to emit a warning signal.

A parallel circuit 24 is integrated into the control circuit 23, wherein the first section 24.1 of said parallel circuit can be opened or closed by a switch 28.1 that is coupled to the rotor stop mechanism 9, while its second section 24.2 can be opened or closed by a switch 28.2 that is coupled to the safety net 10. Switches 28.1 and 28.2 thus mutually bypass one another with their respective closure, allowing a control current that prevents a release of the contactor K to flow in the control circuit 23 as long as at least one of these switches 28.1 and 28.2 is closed.

The opened/closed positions of the switches 28.1 and 28.2 are dependent upon the status of the rotor stop mechanism 9 and the status of the safety net 10 as follows. When the rotor stop mechanism 9 is engaged, the switch 28.1 is closed and thus prevents the contactor K from being released, thereby preventing an activation of the signal emitter 25, independently of the switching position of the switch 28.2. Conversely, when rotor rotation is released, the switch 28.1 is opened and interrupts the flow of current in section 24.1 of the parallel circuit 24. The switch 28.1 is thus in this opened position during normal operation or during test runs of the system 100. During normal operation, therefore, the switch 28.2 in section 24.2 is not bypassed, and the activation of the signal emitter 25 is dependent solely upon the position of the switch 28.2. The latter is closed as long as the safety net 10 is in the secured position, i.e., as long as its tension cable 11 is held under tension by hooking the snap hooks 14 into the eyelets 15. Thus when the safety net 10 is secured, the contactor K is also prevented from being released, the signal emitter 25 is deactivated, and no warning signal is emitted.

if a person follows the safety regulations prior to entering the hub interior 6, after shutting off the system he will first engage the rotor stop mechanism 9, thereby closing the switch 28.1, so that the contactor K is prevented from being released, independently of the switching position of the switch 28.2, and the signal emitter 22 will consequently remain deactivated. Thus when the safety net 10 is subsequently released according to regulations, no warning signal will be emitted.

However, if the safety net 10 is released before the rotor stop mechanism 9 is engaged, contrary to safety regulations, this will cause the switch 28.2 to open while the switch 28.1 is also open, thereby interrupting the flow of current in the control circuit 23 and causing the contactor K to be released. This will result in an activation of the signal emitter 25 in the signal circuit 22, causing it to emit an acoustic warning signal in the form of a loud warning tone. The person is warned that the hub interior 6 cannot yet be safely entered, because the rotor stop mechanism 9 has not yet been engaged. Subsequently engaging the rotor stop mechanism 9 will automatically switch off the alarm.

To control the switching position of the switch 28.1, a sensor is mounted on the rotor stop mechanism 9, which signals its position. For example, the sensor will not send a signal to the control system for the warning device 20 when the rotor stop mechanism 9 is in the released position, but only when the rotor stop mechanism 9 is engaged in the locked position. Alternatively, if an initial preset assignment is made between rotor stop position and switch position, each time the position of the rotor stop mechanism 9 changes a signal can be generated, which causes the switch 28.1 to be thrown. The positioning/configuration of the sensor is such that the sensor will emit its signal indicating the locked position of the rotor stop mechanism only when the rotor stop mechanism is fully engaged. For this purpose, the sensor can be attached directly to a locking bolt of the rotor stop mechanism 9.

For controlling the switching position of the switch 28.2 a sensor is provided, which responds to whether or not the safety net 10 or its tension cable 11 is under a predetermined level of tensile stress. Although this is not illustrated in the figures, a sensitive sensor of this type is integrated into the radially outer area 11a of the tension cable 11. When the tensile stress of the tension cable drops below this preset level, the safety net sensor will signal the release of the safety net 10 to the unsecured status, and the switch 28.2 will open on the basis of this signal. Conversely, the switch 28.2 will receive a closed signal as soon as the tensile force in the tension cable 11 again exceeds the preset tensile force or, if applicable, an additional (second) tensile force that is greater than the aforementioned (first) tensile force, which can be achieved by re-fastening the safety net 10 in the secured position.

The invention is not restricted to the exemplary embodiments described in reference to the attached set of figures. Rather, the characterizing features identified in the specification and in the attached claims, alone or in combination, can be significant to the implementation of the invention in its various embodiments.

1. Wind energy system comprising a tower, a nacelle attached to the tower, the interior of which can be entered, a rotor that is rotatable relative to the nacelle, with a hub, the interior of which adjoins the nacelle interior and is accessible from this via a connecting passage, and comprising a rotor stop mechanism, with which rotor rotation can be enabled in a released position and blocked in a locked position, characterized by a warning device, which is controlled on the basis of the position of the rotor stop mechanism, and which can emit a signal warning against accessing the hub interior (6) when the rotor stop mechanism is in the released position.

2. Wind energy system of claim 1, characterized by a safety device, in particular a safety net, with the secured position thereof preventing access to the hub interior and the unsecured position allowing such access, wherein the warning device is controlled on the basis of the status of said safety device.

3. Wind energy system of claim 2, characterized in that when the safety device is in the secured position, no warning signal is emitted by the warning device.

4. Wind energy system of claim 2, characterized in that the warning device is activated to emit the signal when the safety device is released from its secured position while the rotor stop mechanism is still in the released position.

5. Wind energy system of claim 1, characterized in that the system for controlling the warning device has an electrical switching circuit with a first switch coupled to the rotor stop mechanism, which switch closes when the rotor stop mechanism switches from the released position to the locked position and opens when it switches from the locked position to the released position.

6. Wind energy system of claim 5, characterized in that the electrical switching circuit has a contactor, and when the contactor is acted upon by a control current the warning device is deactivated for emitting the warning signal, and when the control current drops below a preset limiting current the warning device is activated for emitting the warning signal.

7. Wind energy system of claim 6, characterized in that the control current is flowing when the first switch is closed.

8. Wind energy system of claim 6, characterized in that the electrical switching circuit has a second switch coupled to the safety device, which opens when the safety device is changed from the secured status to the unsecured status and closes when the safety device is changed from the unsecured status to the secured status.

9. Wind energy system of claim 8, characterized in that the control current is flowing when the second switch is closed.

10. Wind energy system of claim 2, characterized in that the safety device has a safety element that is under tensile stress when the device is secured.

11. Wind energy system of claim 10, characterized in that the second switch responds to a change in the tensile force of the safety element and opens when the tensile force drops below a preset limit.

12. Wind energy system of claim 1, characterized in that the rotor stop mechanism has a mechanical locking bolt.

13. Wind energy system of claim 5, characterized in that the first switch has a sensor attached to the rotor stop mechanism/the locking bolt.

14. Wind energy system of claim 13, characterized in that the sensor of the first switch responds to the closing process only after the rotor stop mechanism has been fully engaged.

15. Wind energy system of claim 8, characterized in that the second switch has a sensor integrated into the safety element.

16. Wind energy system of claim 1, characterized in that the warning signal contains an optical and/or acoustic signal and is especially an acoustic signal.
